(19) United States
(12) Patent Application Publication
(10) Pub. No.: US 2018/0170494 A1
(43) Pub. Date: Jun. 21, 2018

(54) UNDERWATER ENVIRONMENTAL MONITORING SYSTEMS USING AMPHIBIOUS DRONE

(71) Applicant: GANGNEUNG-WONJU NATIONAL UNIVERSITY INDUSTRY ACADEMY COOPERATION GROUP, Gangneung-si (KR)

(72) Inventors: Sung-Joon Park, Yongin-si (KR); Jun-Ho Jeon, Gangwon-do (KR); Se-Joon Kang, Wonju-si (KR)

(21) Appl. No.: 15/833,979

(22) Filed: Dec. 6, 2017

(30) Foreign Application Priority Data
Dec. 8, 2016 (KR) 10-2016-0167030

(51) Int. Cl. B63G 8/00; G08C 17/02; G01S 15/10; G01S 15/89

(52) U.S. Cl. CPC B63G 8/001; G08C 17/02; G01S 7/521; G01S 15/895; G01S 15/104

(57) ABSTRACT

An underwater environmental monitoring system using an amphibious drone is disclosed. In one aspect, the amphibious drone is configured to generate a measurement data by detecting an underwater environment while moving back and forth between air and water. The underwater environmental monitoring system includes a base station located on the ground and configured to receive the measurement data through radio communication with the amphibious drone.

### INCORPORATION BY REFERENCE TO ANY PRIORITY APPLICATIONS

This application claims the benefit under 35 USC 119(a) of Korean Patent Application No. 10-2016-0167030, filed with the Korean Intellectual Property Office on Dec. 8, 2016, the disclosure of which is incorporated herein by reference in its entirety.

### BACKGROUND

### Field

The described technology generally relates to an underwater environmental monitoring system, more specifically to an underwater environmental monitoring system configured to collect underwater environmental information using an amphibious drone and transmit the collected information using wireless communication.

### Description of the Related Technology

Electromagnetic waves, laser, etc., which are used for ground communication, are not used for underwater communication due to their scattering and attenuating properties, and it is rather common that ultrasonic waves are used, instead of the electromagnetic waves, for underwater communication.

The ultrasonic waves used for underwater communication are slower and have a narrower available bandwidth than the electromagnetic waves, and are reflected on the surface of water. Due to these limitations, uninterrupted communication has not been often unavailable between an underwater monitoring device and a ground station.

Conventionally, in order to solve the above problem, an observer has been on board a vessel in person and monitored the underwater environment while the vessel moved, or has facilitated data communication between the underwater monitoring device and the ground station through underwater communication between the underwater monitoring device and a floating repeater and ground communication between the floating repeater and the ground station by installing a master monitor of KR 10-1213720 or the floating repeater, such as gateway of KR 10-1356605, on the surface of water. However, the data communication has been often interrupted due to the underwater environment, and the monitoring range has been restricted due to the limited capacity of battery installed in the underwater monitoring device when the underwater monitoring device moved a long distance in the water, which has a high frictional drag.

The related art is described in Korean Patent No. 10-1213720 (Dec. 19, 2012) and Korean Patent No. 10-1356605 (Feb. 4, 2014).

The subject matter described in this background section could be pursued, but it has not necessarily been previously conceived or pursued. Therefore, unless otherwise indicated herein, the subject matter described in this background section is not prior art to the claims in this application and is not admitted to be prior art by inclusion in this background section.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Certain embodiments of the present disclosure may provide an underwater environmental monitoring device using an amphibious drone that may overcome data communication impediments caused by an underwater environment and expand a monitoring range.

An aspect of the present disclosure may provide an underwater environmental monitoring system using an amphibious drone that includes: the amphibious drone configured for generating measurement data by detecting underwater environment while moving back and forth between air and water; and base station located on the ground and configured for receiving the measurement data through radio communication with the amphibious drone.

The amphibious drone may include: rotor used for allowing the amphibious drone to move in the air to the sky above a predetermined measurement location; sensor configured for generating the measurement data by detecting the underwater environment at the predetermined measurement location; and second radio communication unit configured for transmitting the measurement data to the base station through radio communication.

The amphibious drone may further include first GPS device configured for generating a coordinate of the amphibious drone, and the amphibious drone may be configured for moving in the air to the sky above the predetermined measurement location by referencing the coordinate of the amphibious drone.

The amphibious drone may further include buoyancy adjusting device configured for adjusting buoyancy of the amphibious drone so as to allow the amphibious drone to move underwater between a surface of water above the predetermined measurement location and the predetermined measurement location.

The rotor may be used for allowing the amphibious drone to move underwater to the predetermined measurement location.

The amphibious drone may further include propulsion device used for allowing the amphibious drone to move underwater to the predetermined measurement location.

The underwater environmental monitoring system may further include repeater station located on a surface of water and configured for receiving the measurement data through ultrasonic communication with the amphibious drone when the amphibious drone is positioned underwater and configured for transmitting the measurement data through radio communication with the base station.

The repeater station may include second GPS device configured for generating a coordinate of the repeater station, and the amphibious drone may be configured for moving underwater from first measurement location to second measurement location by referencing the coordinate of the repeater station.

The amphibious drone may further include first underwater communication unit configured for transmitting the measurement data to the repeater station through ultrasonic communication when the amphibious drone is positioned underwater.

According the disclosed embodiments, by using the amphibious drone that generates the measurement data by detecting the underwater environment and transmits the measurement data in the air through radio communication with the base station on the ground, it is possible to overcome data communication impediments caused by the underwater environment. Moreover, by allowing the amphibious drone to move in the air, which has a relatively lower frictional drag than the water, when the amphibious drone moves from the first measurement location to the second measurement location, especially when the amphibious drone moves a long distance, it is possible to expand the monitoring range that would have been restricted due to the limited capacity of battery installed in the amphibious drone.

According to certain disclosed embodiments, by allowing the amphibious drone to move underwater, rather than in the air, when the amphibious drone moves a short distance, it is possible to save time and energy required for moving the amphibious drone longitudinally. In such a case, the control signals and measurement data of the amphibious drone may be transceived with the repeater station through underwater communication, specifically, ultrasonic communication.

Other features and aspects will be apparent from the following detailed description, the drawings, and the claims.

### BRIEF DESCRIPTION OF THE DRAWINGS

FIG. 1. Illustrates an underwater environmental monitoring system in accordance with an embodiment of the present disclosure.

FIG. 2 is a block diagram illustrating an amphibious drone.

FIG. 3. Illustrates an underwater environmental monitoring system in accordance with another embodiment of the present disclosure.

FIG. 4 is a block diagram illustrating a repeater station.

### DETAILED DESCRIPTION

The terms used in the description are intended to describe certain embodiments only, and shall by no means restrict the present invention. Unless clearly used otherwise, expressions in a singular form include a meaning of a plural form.

In the present description, an expression such as “comprising” or “including” is intended to designate a characteristic, a number, a step, an operation, an element, a part or combinations thereof, and shall not be construed to preclude any presence or possibility of one or more other characteristics, numbers, steps, operations, elements, parts or combinations thereof. Moreover, when one element is described to “send” or “transmit” a signal to another element, it shall be construed as being connected or accessed to the other element directly to send the signal but also as possibly sending the signal by way of another element in between.

The drawings may not be to scale, and the relative size, proportions, and depiction of elements in the drawings may be exaggerated for clarity, illustration, and convenience.

Terms such as “first” and “second” can be used in describing various elements, but the above elements shall not be restricted to the above terms. The above terms are used only to distinguish one element from the other. For instance, the first element can be named the second element, and vice versa, without departing the scope of claims of the present invention. The term “and/or” shall include the combination of a plurality of listed items or any of the plurality of listed items.

Hereinafter, some embodiments of an underwater environmental monitoring system using an amphibious drone in accordance with the present disclosure will be described in detail with reference to the accompanying drawings. Identical or corresponding elements will be given the same reference numerals, regardless of the figure number, and any redundant description of the identical or corresponding elements will not be repeated.

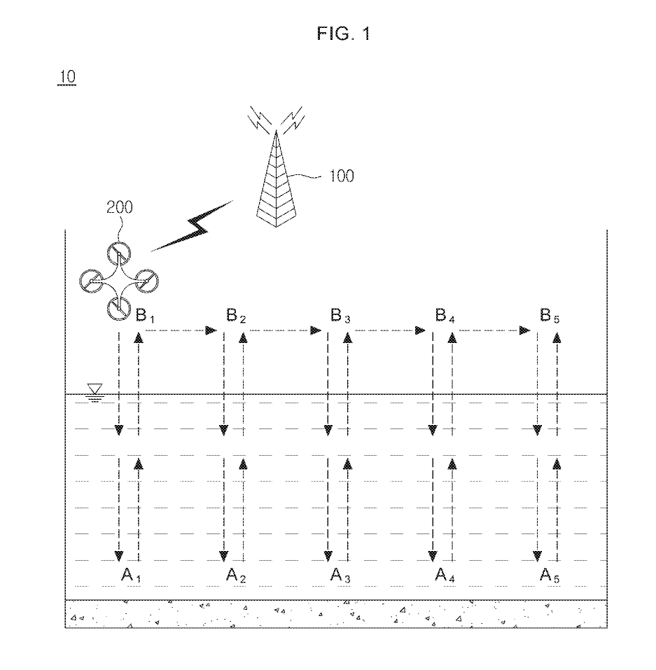

FIG. 1. Illustrates an underwater environmental monitoring system in accordance with an embodiment of the present disclosure.

Referring to FIG. 1, an underwater environmental monitoring system 10 in accordance with the disclosed embodiment may include a base station 100 and an amphibious drone 200.

The base station 100 may be located on the ground.

The base station 100 may be configured to control the amphibious drone 200 by transmitting control signals to the amphibious drone 200 through radio communication for controlling an operation of the amphibious drone 200 when the amphibious drone 200 is in the air and configured to receive particular data transmitted by the amphibious drone 200 through radio communication when the amphibious drone 200 is in the air. For this, the base station 100 may include first radio communication unit.

The amphibious drone 200 may move back and forth between air and water to detect underwater environment and generate measurement data. Movement routes of the amphibious drone 200 are shown with arrows in FIG. 1.

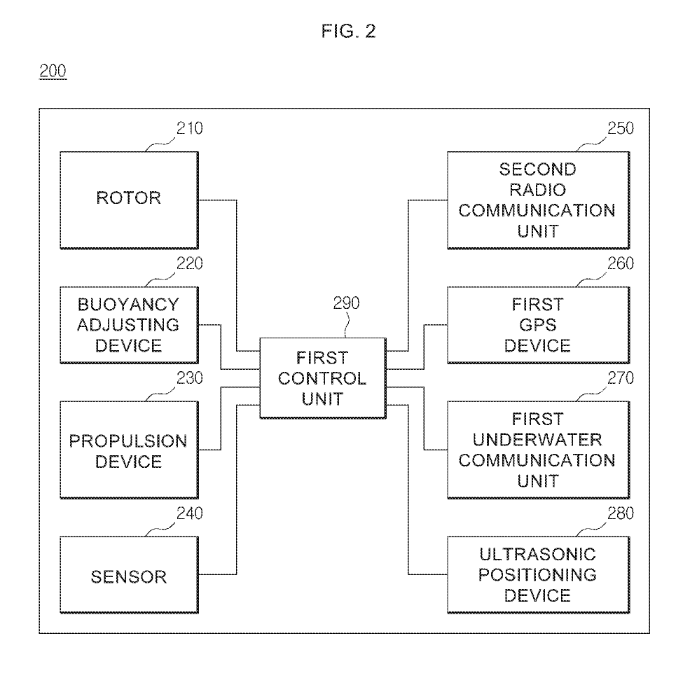

FIG. 2 is a block diagram illustrating an amphibious drone.

Referring to FIG. 2, the amphibious drone 200 may include rotor 210, buoyancy adjusting device 220, propulsion device 230, sensor 240, second radio communication unit 250, first GPS device 260 and first control unit 290.

Air movement of the amphibious drone 200 may be made by rotary motion of the rotor 210.

The air movement of the amphibious drone 200 may include a lateral movement such as, for example, a movement from sky B1 above first measurement location A1 to sky B2 above second measurement location A2, and a longitudinal movement such as, for example, a movement from the sky B2 above the second measurement location A2 to a surface of water above the second measurement location A2.

Underwater movement of the amphibious drone 200 may include a longitudinal movement such as, for example, a movement from the surface of water above the second measurement location A2 to the second measurement location A2.

In an example, the underwater movement of the amphibious drone 200 may be made by rotary motion of the rotor 210.

In another example, the underwater movement of the amphibious drone 200 may be made by the buoyancy adjusting device 220, which may be configured to adjust a buoyancy of the amphibious drone 200. For example, the buoyancy adjusting device 220 may decrease the buoyancy of the amphibious drone 200 to allow the amphibious drone 200 to descend from the surface of water above the second measurement location A2 to the second measurement location A2 and may increase the buoyancy of the amphibious drone 200 to allow the amphibious drone 200 to ascend from the second measurement location A2 to the surface of water above the second measurement location A2. The buoyancy adjusting device 220 may include a ballast tank installed in the amphibious drone 200.

In yet another example, the underwater movement of the amphibious drone 200 may be made by the propulsion device 230, which may include a thruster installed in the amphibious drone 200.

The sensor 240 may generate measurement data by detecting the underwater environment when the amphibious drone 200 is positioned at any of measurement locations A1-A5. The sensor 240 may include at least one of known sensors, including temperature sensor, hydraulic pressure sensor, radiation sensor, etc.

The second radio communication unit 250 may transmit measurement data to the base station 100 through radio communication when the amphibious drone 200 is positioned in the air. Moreover, the second radio communication unit 250 may receive control signals transmitted by the base station 100 for controlling the operation of the amphibious drone 200 when the amphibious drone 200 is positioned in the air.

The first GPS device 260 may generate a current coordinate of the amphibious drone 200 by receiving signals from satellites when the amphibious drone 200 is positioned in the air.

The first control unit 290 may control every element constituting the amphibious drone 200 such that the amphibious drone 200 can be properly operated. For example, the first control unit 290 may control the rotor 210 to allow the amphibious drone 200 to move from the sky B1 above the first measurement location A1 to the sky B2 above the second measurement location A2 by referencing a coordinate of the sky B2 above the second measurement location A2 generated by the base station 100 and received by the second radio communication unit 240 and the current coordinate of the amphibious drone 200 generated by the first GPS device 260. Meanwhile, power required for various electric and mechanical devices installed in the amphibious drone 200 may be supplied by, for example, a battery installed in the amphibious drone 200.

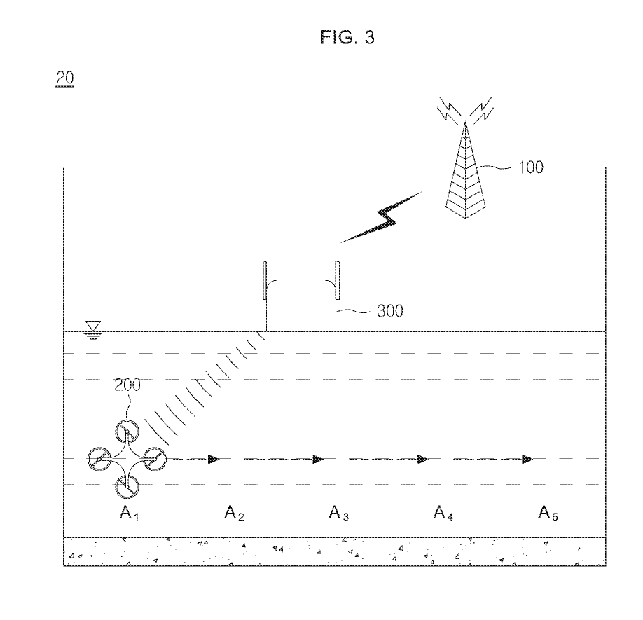

FIG. 3. Illustrates an underwater environmental monitoring system in accordance with another embodiment of the present disclosure.

Referring to FIG. 3, an underwater environmental monitoring system in accordance with another disclosed embodiment may further include a repeater station 300.

Base station 100 may transmit control signals for controlling an operation of amphibious drone 200 to the repeater station 300 when the amphibious drone 200 is positioned in the air, and may receive measurement data transmitted by the repeater station 300 through radio communication.

Not only may the amphibious drone 200 move horizontally in the air, as illustrated in FIG. 1, but the amphibious drone 200 may move horizontally underwater, as illustrated in FIG. 3, in order to save time and energy required for longitudinal movement if a distance for horizontal movement is relatively short. The routes for underwater movement of the amphibious drone 200 are illustrated in arrows in FIG. 3.

The underwater horizontal movement of the amphibious drone 200 may be made by rotary motion of rotor 210 or by propulsion device 230. Orientation of the rotor 210 or the propulsion device 230 may be controlled in order to perform the underwater longitudinal movement and horizontal movement of the amphibious drone 200 simultaneously.

The amphibious drone 200 may further include first underwater communication unit 270 and ultrasonic positioning device 280.

The first underwater communication unit 270 may transmit measurement data to the repeater station 300 through ultrasonic communication when the amphibious drone 200 is positioned underwater. Moreover, the first underwater communication unit 270 may receive control signals for controlling an operation of the amphibious drone 200 transmitted by the repeater station 300 through ultrasonic communication when the amphibious drone 200 is positioned underwater.

The ultrasonic positioning device 280 may compute a coordinate of the amphibious drone 200 relative to the repeater station 300.

First control unit 290 may control the rotor 210 or the propulsion device 230 so as to allow the amphibious drone 200 to move from first measurement location A1 to second measurement location A2 underwater by referencing a coordinate of the second measurement location A2 generated by the base station and received by the first underwater communication unit 270, the coordinate of the repeater station 300 generated by the repeater station 300 and received by the first underwater communication unit 270 and the coordinate of the amphibious drone 200 relative to the repeater station 300 computed by the ultrasonic positioning device 280.

The repeater station 300 may be located on a surface of water.

The repeater station 300 may receive the control signals for controlling the operation of the amphibious drone 200 from the base station 100 through radio communication and transmit the received control signals to the amphibious drone 200 through ultrasonic communication, and may receive measurement data from the amphibious drone 200 through ultrasonic communication and transmit the received measurement data to the base station 100 through radio communication.

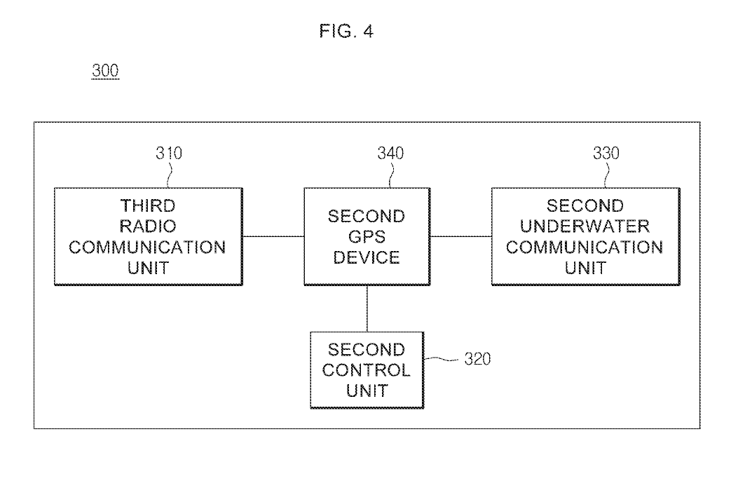

FIG. 4 is a block diagram illustrating the repeater station.

Referring to FIG. 4, the repeater station 300 may include third radio communication unit 310, second GPS device 320, second underwater communication unit 330 and second control unit 340.

The third radio communication unit 310 may receive the control signals for controlling the amphibious drone 200 from the base station 100 through radio communication, and may transmit the measurement data received from the amphibious drone 200 to the base station 100 through radio communication.

The second GPS device 320 may generate the coordinate of the repeater station 300 by receiving signals from satellites.

The second underwater communication unit 330 may receive the measurement data from the amphibious drone 200 through ultrasonic communication when the amphibious drone 200 is positioned underwater, and may transmit the control signals for controlling the operation of the amphibious drone 200 received from the base station 100 through ultrasonic communication when the amphibious drone 200 is positioned underwater. Moreover, the second underwater communication unit 330 may also transmit a coordinate of the repeater station 300 generated by the second GPS device 320 to the amphibious drone 200 through ultrasonic communication.

The second control unit 340 may control every element constituting the repeater station 300 so as to allow the repeater station 300 to operate properly. Meanwhile, power required for various electric and mechanical devices installed in the repeater station 300 may be supplied by, for example, a battery installed in the repeater station 300.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Therefore, the scope of the disclosure is defined not by the detailed description, but by the claims and their equivalents, and all variations within the scope of the claims and their equivalents are to be construed as being included in the disclosure.

What is claimed is:

1. An underwater environmental monitoring system using an amphibious drone, comprising:
the amphibious drone configured to generate a measurement data by detecting an underwater environment while moving back and forth between air and water; and
a base station located on the ground and configured to receive the measurement data through radio communication with the amphibious drone.

2. The underwater environmental monitoring system of claim 1, wherein the amphibious drone comprises:
a rotor configured to allow the amphibious drone to move in the air to the sky above a predetermined measurement location;
a sensor configured to generate the measurement data by detecting the underwater environment at the predetermined measurement location; and
a second radio communication unit configured to transmit the measurement data to the base station through radio communication.

3. The underwater environmental monitoring system of claim 2, wherein the amphibious drone further comprises a first GPS device configured to generate a coordinate of the amphibious drone, and
wherein the amphibious drone is configured to move in the air to the sky above the predetermined measurement location by referencing the coordinate of the amphibious drone.

4. The underwater environmental monitoring system of claim 2, wherein the amphibious drone further comprises a buoyancy adjusting device configured to adjust buoyancy of the amphibious drone so as to allow the amphibious drone to move underwater between a surface of water above the predetermined measurement location and the predetermined measurement location.

5. The underwater environmental monitoring system of claim 2, wherein the rotor is configured to allow the amphibious drone to move underwater to the predetermined measurement location.

6. The underwater environmental monitoring system of claim 2, wherein the amphibious drone further comprises a propulsion device configured to allow the amphibious drone to move underwater to the predetermined measurement location.

7. The underwater environmental monitoring system of claim 5, further comprising a repeater station located on a surface of water and configured to receive the measurement data through ultrasonic communication with the amphibious drone when the amphibious drone is positioned underwater and configured to transmit the measurement data through radio communication with the base station.

8. The underwater environmental monitoring system of claim 7, wherein the repeater station comprises a second GPS device configured to generate a coordinate of the repeater station, and
wherein the amphibious drone is configured to move underwater from a first measurement location to a second measurement location by referencing the coordinate of the repeater station.

9. The underwater environmental monitoring system of claim 8, wherein the amphibious drone further comprises a first underwater communication unit configured to transmit the measurement data to the repeater station through ultrasonic communication when the amphibious drone is positioned underwater.
